(19) United States
(12) Patent Application Publication
(10) Pub. No.: US 2015/0229203 A1
(43) Pub. Date: Aug. 13, 2015

(54) Smart Resistor-Less Pre-Charge Circuit For Power Converter

(71) Applicants: Gholamreza Esmaili, San Diego, CA (US); Joseph Gottlieb, Poway, CA (US); Kevin Michael Clark, San Diego, CA (US); Farhad Hassani, Poway, CA (US)

(72) Inventors: Gholamreza Esmaili, San Diego, CA (US); Joseph Gottlieb, Poway, CA (US); Kevin Michael Clark, San Diego, CA (US); Farhad Hassani, Poway, CA (US)

(21) Appl. No.: 14/178,734

(22) Filed: Feb. 12, 2014

(51) Int. Cl. H02M 1/36; H02M 7/04

(52) U.S. Cl. CPC H02M 1/36; H02M 7/04

(57) ABSTRACT

A resistor-less device for limiting inrush current in power system startup, for a DC-link capacitor. A DC-link capacitor is coupled to an output of an AC power source rectifying circuit, providing a DC-bus voltage. A current direction sensitive, controllable electrical switch comprising a reverse based diode in parallel with a controllable forward based diode, is in series connection with the DC-link capacitor. A diode controller is coupled to the controllable forward based diode, controlling a conducting state of the forward based diode. A system measurement signal is input to the diode controller and a diode controller module having decision logic, uses the system measurement signal to turn “on” the conducting (or non-conducting) state of the controllable forward based diode, at a predetermined time and duration, wherein inrush current on a system startup is limited.

### FIELD

This invention relates to limiting inrush current in a DC link capacitor. More particularly, it relates to resistor-less, safe charging of a DC link capacitor in a power inverter system.

### BACKGROUND

Power conversion from an AC state to a DC state or vice versa is typically arrived at by having the AC source's power rectified by a rectifying converter , the output of which is coupled to a DC-bus link that feeds a DC load or to a subsequent inverter (for conversion from DC back to a well regulated AC). The DC-bus link voltage is held at a “stable” value by what is called the DC-link capacitor. This is the de facto approach for single and multiple (e.g., three) phase systems in the industry. However, it is well known that upon initial charging, the DC-link capacitor first appears as a near zero voltage causing a very large inrush current. This inrush current can be several times the normal operating current and can damage devices within the current path. Further, with large currents, the line voltage will vary, setting off low voltage alarms, etc. Conventional approaches to addressing this have been to place a resistor in the current path to reduce the magnitude, however, this introduces a lossy element that consumes power during normal operation. This is mitigated to some degree by having the resistor removed (via a switch) after the DC-link capacitor is charged. Unfortunately, the resistor must still be matched to the AC source and of high wattage, otherwise it can fail resulting in uncontrolled inrush current damaging the overall system.

In view of the above, there has been a long standing need in the community for alternative methods and systems for charging the DC-link capacitor without the limitations of an inrush current limiting resistor/switch system. Accordingly, aspects of new methods and systems addressing these and other deficiencies in the prior art are elucidated in the following description.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one aspect of the disclosed embodiments, a resistor-less device for limiting inrush current in power system startup, for a DC-link capacitor is provided, comprising: a DC-link capacitor configurable to be coupled to an output of an AC power source rectifying circuit, to provide a DC-bus voltage; a current direction sensitive, controllable electrical switch comprising a reverse based diode in parallel with a controllable forward based diode, in series connection with the DC-link capacitor; a diode controller, coupled to the controllable forward based diode, controlling a conducting state of the forward based diode; a system measurement signal input to the diode controller; and a diode controller module having decision logic, using the system measurement signal, to turn on the conducting (or non-conducting) state of the controllable forward based diode, at a predetermined time and duration, wherein inrush current on a system startup is limited.

In other aspects of the disclosed embodiments, the above device for limiting inrush current in power system startup is provided, further comprising an AC power source; and/or wherein the AC power source is a single phase power source; and/or the rectifying circuit is an inverter bridge; and/or wherein the controllable forward based diode is a thyristor; and/or wherein the system measurement signal includes at least one of an AC power source voltage measurement and a system line current measurement; and/or wherein the controller is remotely connected to the controllable forward based diode; and/or wherein the decision logic is remote from the controller.

In another aspect of the disclosed embodiments, a resistor-less method for limiting inrush current in power system startup, for a DC-link capacitor is provided, comprising: connecting a DC-link capacitor configurable to an output of an AC power source rectifying circuit, to provide a DC-bus voltage; connecting a current direction sensitive, controllable electrical switch comprising a reverse based diode in parallel with a controllable forward based diode, in series with the DC-link capacitor; connecting a diode controller to the controllable forward based diode, to control a conducting state of the forward based diode; connecting a system measurement signal input to the diode controller; and operating decision logic, using the system measurement signal, to turn on via the controller the conducting state of the controllable forward based diode, at a predetermined time and duration, wherein inrush current on a system startup is limited.

In other aspects of the disclosed embodiments, the above method is provided, wherein the AC power source is a single phase power source; and/or wherein the rectifying circuit is an inverter bridge; and/or wherein the controllable forward based diode is a thyristor; and/or wherein the system measurement signal includes at least one of an AC power source voltage measurement and a system line current measurement; and/or wherein the controller is remotely connected to the controllable forward based diode; and/or wherein the decision logic is remote from the controller.

### BRIEF DESCRIPTION OF THE DRAWINGS

FIG. 1 is a schematic illustration of a typical prior art inrush current limiting system.

FIG. 2 shows a simulation of the prior art embodiment of FIG. 1 with a nearly zero inrush current limiting resistance.

FIG. 3 shows a simulation of the prior art embodiment of FIG. 1 with an inrush current limiting resistance of 10 Ohms.

FIG. 4 shows a simulation prior art embodiment of FIG. 1 with an inrush current limiting resistance of 20 Ohms.

FIG. 5 is a schematic illustration of a three phase converter with an embodiment of a resistor-less pre-charge circuit.

FIG. 6 is a schematic illustration of a single phase converter with an embodiment of a resistor-less pre-charge circuit.

FIG. 7 is a schematic illustration of an embodiment of a resistor-less inrush limiting system.

FIG. 8 shows simulation results, over extended cycles (˜2 s), using the embodiment of FIG. 7.

FIG. 9 shows simulation results, over extended cycles (˜150 ms), using the embodiment of FIG. 7.

### DETAILED DESCRIPTION

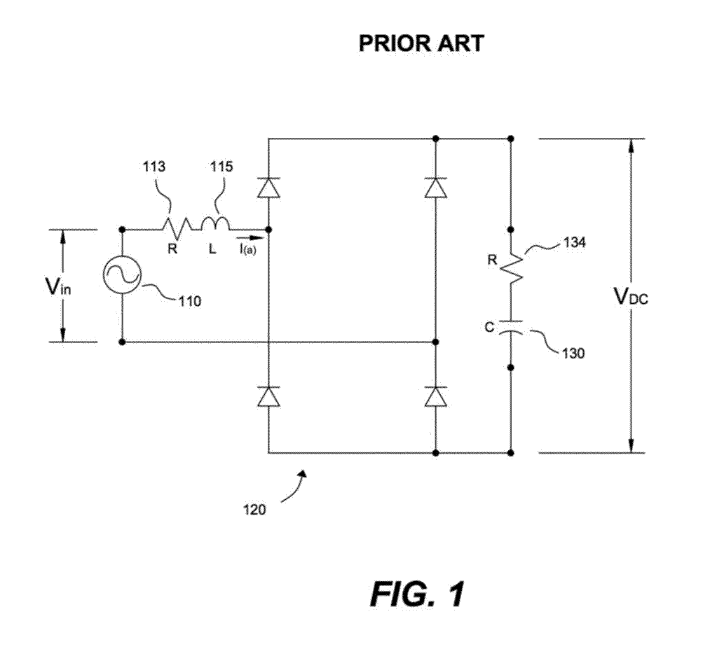

FIG. 1 is a schematic illustration 100 of a typical prior art inrush current limiting system, having a single phase AC power source 110 having a Vᵢₙ value, with inrush current limiting resistor (R_{L}) 113 optionally located between the AC power source 110 and rectifier bridge 120. Inductance (L) 115 shown here represents arbitrary line inductance. The output of the rectifier bridge 20 is bridged by DC-link capacitor (C) 130 having inrush current limiting resistor (R_{L}) 134 at its secondary optional location in series with DC-link capacitor 130. It is noted that this diagram 100 shows two possible locations for the limiting resistor R_{L}. Typically, the limiting resistor R_{L} will be placed downstream from the AC power source 110, which is coincident with inrush current limiting resistor's 113 location. However, it possible to place the limiting resistor at inrush current limiting resistor's 134 location. V_{dc} 140 represents the DC-link bus voltage 130 across the “output” of the DC-link capacitor 130, which includes the if coupled inrush current limiting resistor 134. For the following examples, inrush limiting resistor R_{L} will correspond to the location of inrush current limiting resistor 113. For these examples, the AC source voltage is set at 340V (peak, or 240 RMS) and regulating line inductance 115 is set at 1 mH. The DC-link capacitor 130 is set at 2000 uF, which is understood to help stabilize the voltage across the DC-bus link (aka V_{dc}). This system is representative of typical inrush limiting systems and is well understood in the art.

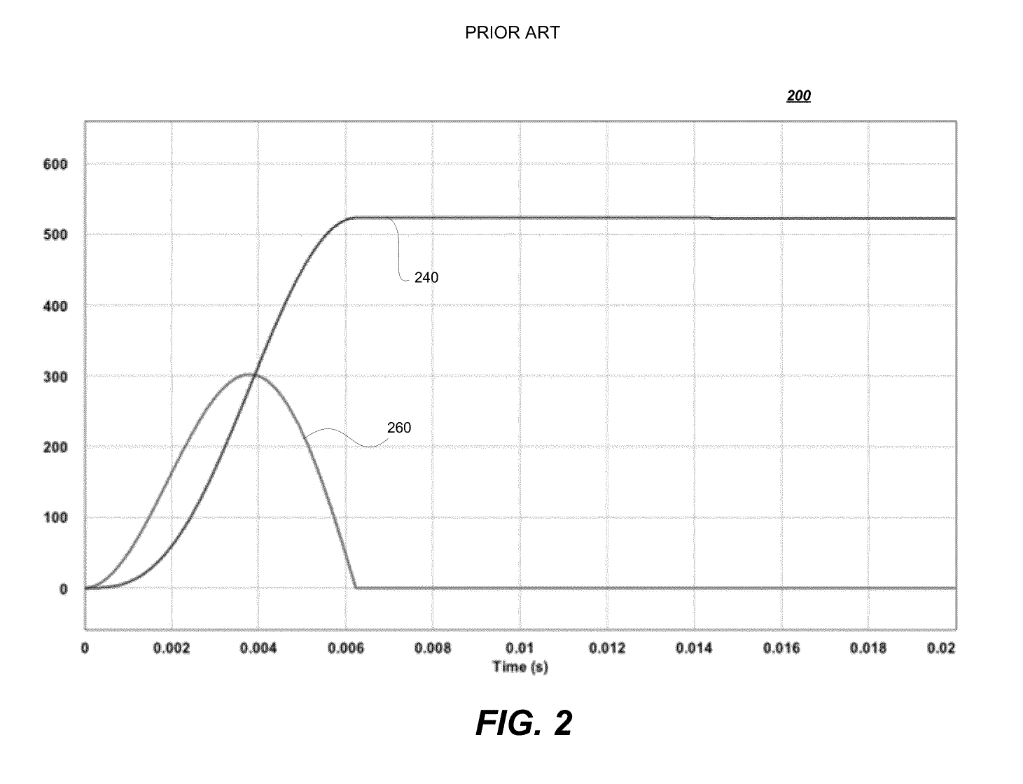

FIGS. 2-5 are computer simulations of the prior art system of FIG. 1, showing amplitude versus time plots of the inrush current I(a) (measured from the AC power source 110) and output voltage 140 (V_{dc}) as the inrush current limiting resistor 113 value is varied. FIG. 2 shows a simulation 200, wherein the inrush current limiting resistor 113 is set to a de minimis value of 0.1 Ohms (essentially representing the no-resistor scenario). Assuming a 60 Hz AC power system, the 20 ms period represents one full cycle. Evident are the high peak of approximately 300 A for the simulated inrush current 260 for the simulated input voltage 240, in less than 20 ms. Clearly this example shows the deleterious effects of having no significant resistance to limit inrush current.

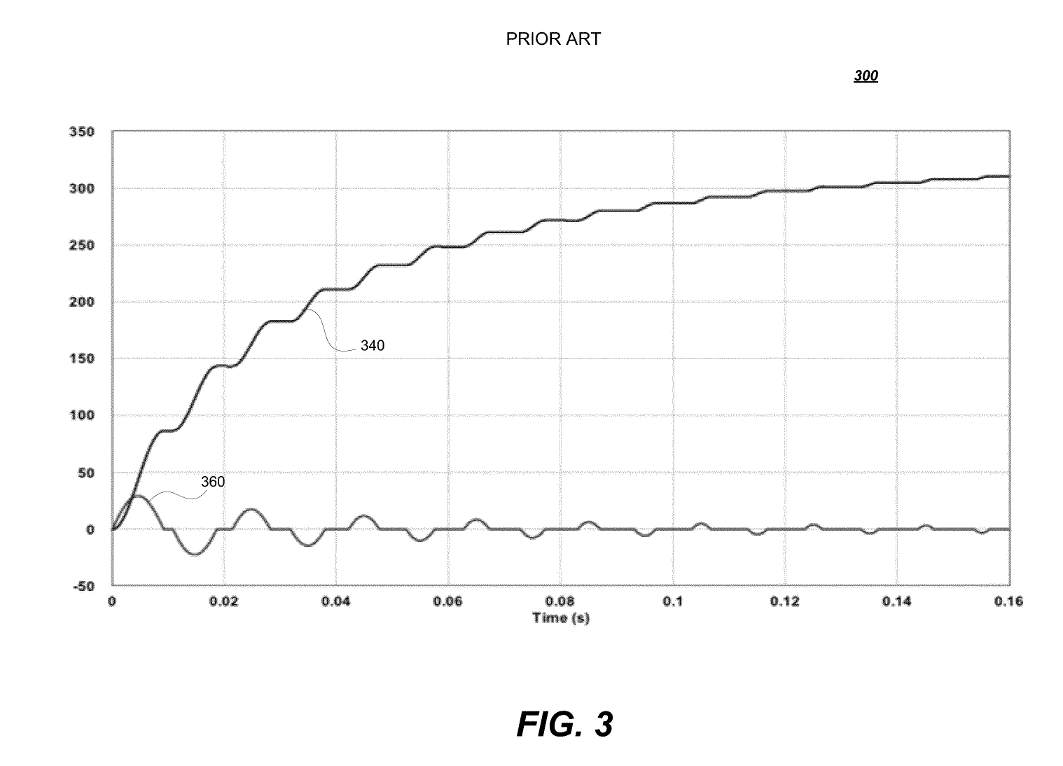

FIG. 3 shows a simulation 300, extended over several cycles, wherein the inrush current limiting resistor 113 is raised to 10 Ohms in an attempt to reduce the current peak. Here, the simulated inrush current 360 has a first cycle peak that is around 30 A and the simulated output voltage 340 rises gradually to around 310V within 160 ms, which is an improvement over the simulation of FIG. 2.

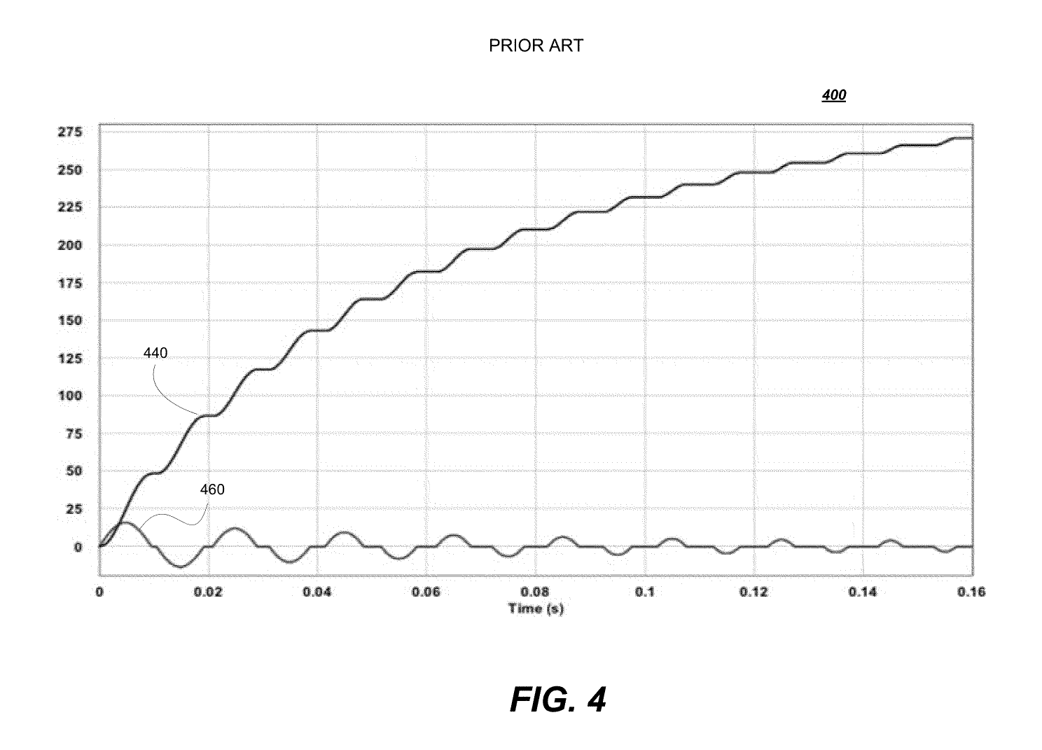

FIG. 4 shows a simulation 400, over several cycles, wherein the inrush current limiting resistor 113 is raised to 20 Ohms. Here, the simulated inrush current 460 has a first cycle peak that is around 15 A and the simulated output voltage 440 rises gradually to around 270V within 160 ms, which is an improvement over the simulation of FIG. 3.

The inclusion of an inline resistor to limit inrush current is not without its shortcomings, as described above. Therefore, various embodiments are described below for a resistor-less, pre-charge system for the DC-link bus, which allows for dynamic control of the inrush current and the line voltage.

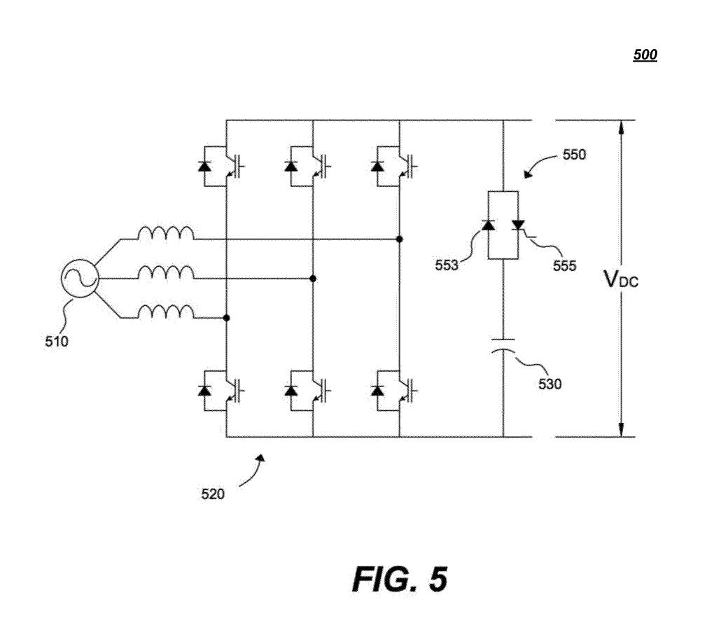

FIG. 5 is a schematic illustration 500 of a DC-link circuit with an embodiment of a controllable pre-charge circuit 550. AC source 510 (shown here as a three-phase source) is coupled to a three phase actively controlled inverter bridge 520. The rectified DC output of the inverter bridge 520 is coupled to a link capacitor 530 having pre-charge circuit 550 composed of a parallel circuit of opposing “diodes.” Reverse biased diode 553 blocks current from inverter bridge 520 from flowing into link capacitor 535, but allows current to flow out of the link capacitor 535 for the output voltage V_{dc}, to a subsequent load or system (not shown). Forward biased diode 555 allows current flow into link capacitor 535 from inverter bridge 520, but diode 555 is not a typical diode, but a controllable diode. Being controllable, means that diode 555 can be “switched” on or switched off to allow precise durations of current flow, thus operating to limit inrush current from AC source 510.

The switchable diode 555 can be facilitated by a series circuit of a standard forward biased diode with a simple latching switch, for example, having high speed mechanical opening and closing capabilities. However, a very effective semiconductor switch having equivalent capabilities can be found in a thyristor. Thyristors lend themselves to rapid turning on, via software or electrical signal control. The activation process is referred to as “firing” the thyristor. It should be appreciated that while the following description uses thyristors as the device of preference, other applicable solid state switching devices with a built in or connected current direction sensitivity may be employed, without departing from the spirit and scope of this disclosure.

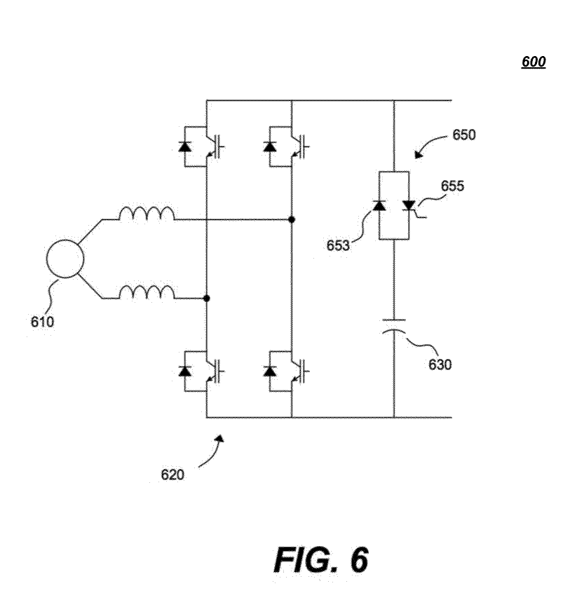

FIG. 6 is a schematic illustration 600 of a DC-link circuit with a pre-charge circuit 650 with diode 653 and thyristor 655 coupled to DC-link capacitor 630. AC source 610 (shown here as a single-phase source) is coupled to single phase rectifying bridge 620. This embodiment is similar to the embodiment of FIG. 5, but configured for a single-phase power converter.

It is evident from FIGS. 5 and 6, that by controlling the operation of switchable diodes (e.g., thyristors) 555, 655, inrush current can be limited during startup. Firing of the thyristors 555, 655 can be controlled from 180° to 0° during the start-up time. for example. The longer the startup time, the better the peak inrush current can be managed to be smaller, by controlling the firing angle. Moreover, the embodiments can discharge the DC-link through the output converter or load (not shown). Also, as there is no limiting resistor, losses can be avoided, in contrast to the prior art designs.

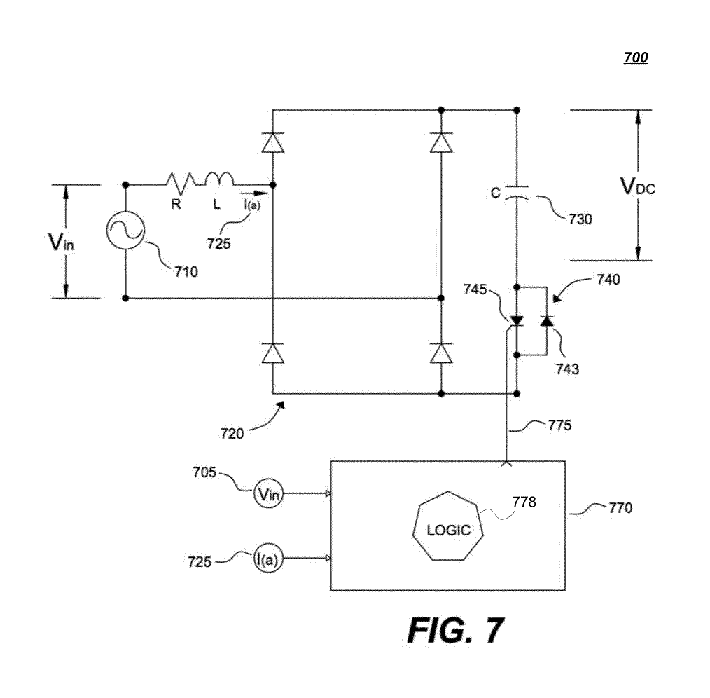

FIG. 7 is a schematic illustration 700 of a simulated resistor-less inrush limiting system, having a single phase AC power source 710 with voltage Vᵢₙ. For the purposes of illustration, a peak voltage of 340V (or 240 RMS) is designated for the AC power source 710. Of course, other voltages may be utilized. While FIG. 7 is an illustration of a single phase system, the embodiment can be easily modified for multiple phase (e.g., 3 phase) as generally understood from FIG. 6, by one of ordinary skill without departing from the spirit and scope of this disclosure.

Presuming an arbitrary line resistance (R)714 of 0.1 Ohms (for simulation purposes, this small value of resistance essentially means no inrush current limiting resistor is in the circuit) and line inductance (L) 715 of 1 mH, the AC power source 710 is connected to rectifying bridge 720, which is connected to DC-link capacitor (C) 730 having a designated value of 2000 uF in series with limiting circuit 740, having reverse diode 743 and thyristor 745. While a rectifying bride 720 is shown, it is expressly understood that an inverter bridge, as seen in FIG. 6, or similarly functioning circuit can be used.

Thyristor 745 is turned on and off through link 775 via controller 770 which can use measured source voltage Vᵢₙ (705) and measured line current I(a) 725, as inputs for logic module 778 for determining thyristor firing times and durations. As stated above, the operation of the thyristor 745 on a per cycle basis determines how much current is fed into DC-link capacitor 730, which ultimately controls the amount of inrush current and effect on the attendant line voltage. For the following simulation results, the output DC voltage (V_{dc}) is presumed to be across DC-link capacitor 730.

In some embodiments, limiting circuit 740 may be placed “above” DC-link capacitor 730, with no loss of functionality. In other embodiments, various control considerations may be implemented. For example, a time limit for the duration of pre-charging can be designated (e.g., t(pre-charge)), which can be “fired” to by thyristor 745. This can set the extent of time necessary for full charge of the DC-link capacitor 730. However, to avoid any unmanageable inrush current, a max inrush current limit (e.g., I(limit)) can be designated, which would have priority over t(pre-charge), when determining duration and firing angle of thyristor 745. Inputs Vᵢₙ 705 and I(a) 725 operate as giving controller 770 information on what the actual currents/voltages are in the system, wherein the controller 770 can assess its next firing angle and/or duration, in consideration of t(pre-charge) and I(limit), via logic module 778. It is understood that t(pre-charge) and/or I(limit) may be set at a fixed value, or altered by controller in view of other considerations. For example, t(pre-charge) and/or I(limit) may not be a single value but a range of acceptable values that controller 770 is constrained to operate within.

Controller 770 may be a software controller processor, computer, logic device, having memory and instruction storage/execution capabilities, which may be embodied in logic module 778 or remotely, depending on implementation preference. As such, controller 770 can be facilitated by any one or more types of systems (digital, analog, etc.), wherein the details of such a controller and associated software (e.g., logic module 778) are known to be within the purview of one of ordinary skill in the art. Controller 770 can be a remote device, wirelessly controlling thyristor 745, or controller 770 can be on on-site processor.

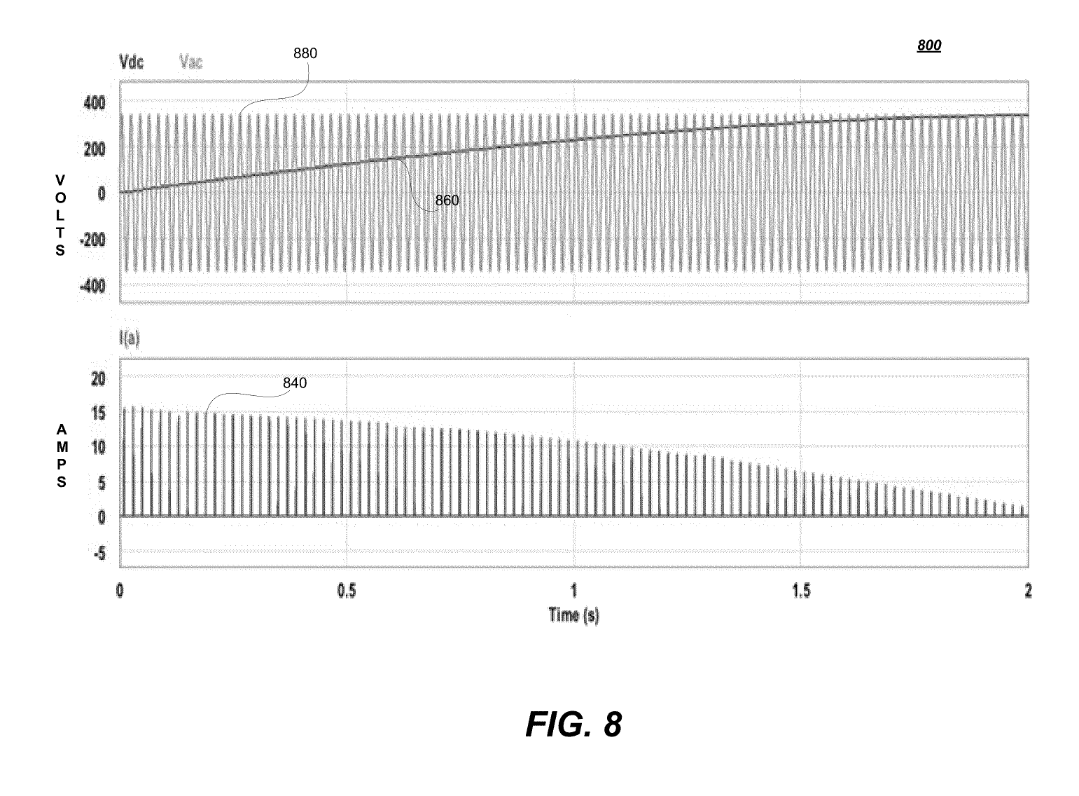

FIG. 8 shows simulation 800 results, over extended cycles (˜2 s), using the embodiment of FIG. 7. The top plot shows a comparison of V_{dc} 880 (measured across DC-link capacitor 730) and Vᵢₙ 860 (measured across AC power source 710). Using a t(pre-charge) value of approximately 2 s, it is evident that Vᵢₙ 860 is stable being held approximately at its 340V peak per each cycle. Also, the V_{dc} 860 value is shown to gradually rise per cycle, eventually arriving at full value under 2 s. Of significant importance is the bottom plot, showing the line current I(a) 840 as having a maximum value of approximately 15 A and gradually reducing to 2 A by 2 s. This shows the clear inrush current limiting effects of invention.

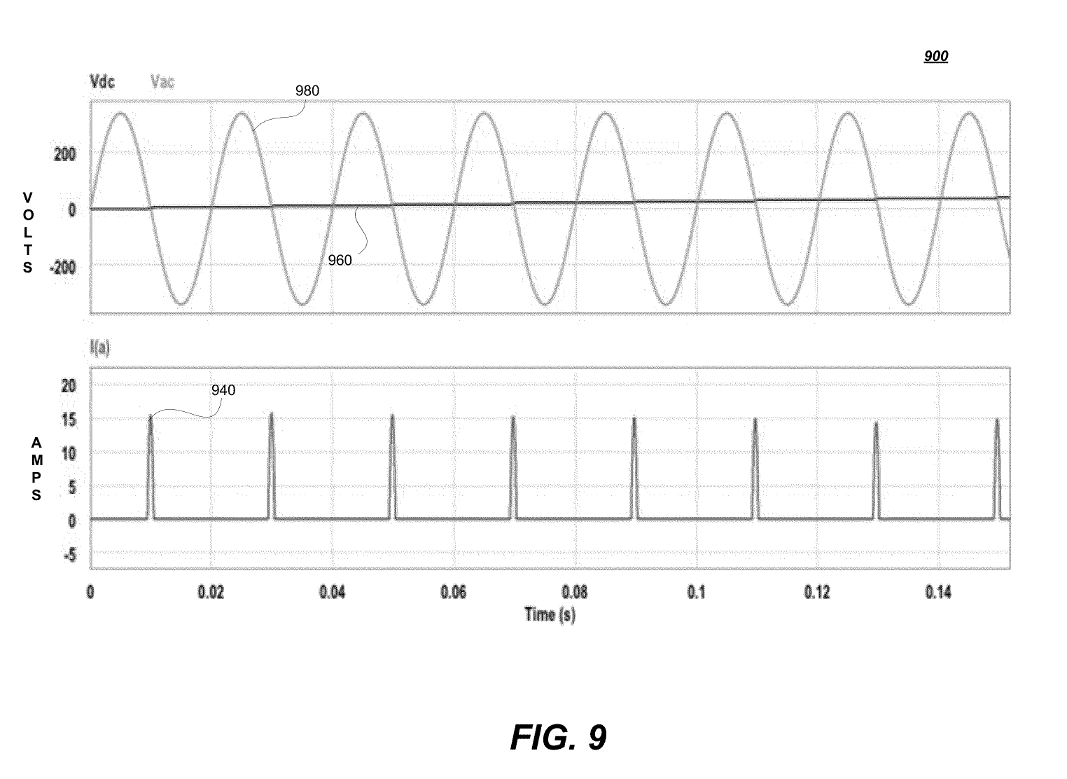

FIG. 9 shows simulation 900 results, over a shorter time period (˜150 ms), using the embodiment of FIG. 7. This plot helps to see what is happening within the first cycles where large inrush currents are expected to be most evident. From the top plot, it is evident that Vᵢₙ 980 is stable being held approximately at its 340V peak per each cycle. The V_{dc} 960 value is shown to gradually rise per cycle, showing gradual charging of the DC-link capacitor 730. Bottom plot, shows the line current I(a) 940 as having a maximum value of approximately 15 A and gradually dropping with each cycle. This confirms the above observation that inrush current is essentially controlled to a manageable level, without the use of inrush current limiting resistors.

It should be noted that the controller 770 may be integrated into overall system or separate, being a computer or processing device under software operation. Therefore, as will be appreciated by one skilled in the art, the present disclosure may be embodied as an apparatus that incorporates some software components. Accordingly, some embodiments of the present disclosure, or portions thereof, may combine one or more hardware components such as microprocessors, microcontrollers, or digital sequential logic, etc., such as processor with one or more software components (e.g., program code, firmware, resident software, micro-code, etc.) stored in a tangible computer-readable memory device such as a tangible computer memory device, that in combination form a specifically configured apparatus that performs the functions as described herein. These combinations that form specially-programmed devices may be generally referred to herein “modules”. The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, and the like. A given module may even be implemented such that the described functions are performed by separate processors and/or computing hardware platforms.

The foregoing is illustrative only and is not intended to be in any way limiting. Reference is made to the accompanying drawings, which form a part hereof. In the drawings, similar symbols typically identify similar components, unless context dictates otherwise.

Note that the functional blocks, methods, devices and systems described in the present disclosure may be integrated or divided into different combinations of systems, devices, and functional blocks, as would be known to those skilled in the art.

In general, it should be understood that the circuits described herein may be implemented in hardware using integrated circuit development technologies, or via some other methods, or the combination of hardware and software objects could be ordered, parameterized, and connected in a software environment to implement different functions described herein. For example, the present application may be implemented using a general purpose or dedicated processor running a software application through volatile or non-volatile memory. Also, the hardware objects could communicate using electrical signals, with states of the signals representing different data.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, implementations, and realizations, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those skilled in the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A resistor-less device for limiting inrush current in power system startup, for a DC-link capacitor, comprising:
a DC-link capacitor configurable to be coupled to an output of an AC power source rectifying circuit, to provide a DC-bus voltage;
a current direction sensitive, controllable electrical switch comprising a reverse based diode in parallel with a controllable forward based diode, in series connection with the DC-link capacitor;
a diode controller, coupled to the controllable forward based diode, controlling a conducting state of the forward based diode;
a system measurement signal input to the diode controller; and
a diode controller module having decision logic, using the system measurement signal, to turn on the conducting state of the controllable forward based diode, at a predetermined time and duration,
wherein inrush current on a system startup is limited.

2. The device of claim 1, further comprising an AC power source.

3. The device of claim 2, wherein the AC power source is a single phase power source.

4. The device of claim 1, wherein the rectifying circuit is an inverter bridge.

5. The device of claim 1, wherein the controllable forward based diode is a thyristor.

6. The device of claim 1, wherein the system measurement signal includes at least one of an AC power source voltage measurement and a system line current measurement.

7. The device of claim 1, wherein the controller is remotely connected to the controllable forward based diode.

8. The device of claim 1, wherein the decision logic is remote from the controller.

9. A resistor-less method for limiting inrush current in power system startup, for a DC-link capacitor, comprising:
connecting a DC-link capacitor configurable to an output of an AC power source rectifying circuit, to provide a DC-bus voltage;
connecting a current direction sensitive, controllable electrical switch comprising a reverse based diode in parallel with a controllable forward based diode, in series with the DC-link capacitor;
connecting a diode controller to the controllable forward based diode, to control a conducting state of the forward based diode;
connecting a system measurement signal input to the diode controller; and
operating decision logic, using the system measurement signal, to turn on via the controller the conducting state of the controllable forward based diode, at a predetermined time and duration,
wherein inrush current on a system startup is limited.

10. The method of claim 9, wherein the AC power source is a single phase power source.

11. The method of claim 9, wherein the rectifying circuit is an inverter bridge.

12. The method of claim 9, wherein the controllable forward based diode is a thyristor.

13. The method of claim 9, wherein the system measurement signal includes at least one of an AC power source voltage measurement and a system line current measurement.

14. The method of claim 9, wherein the controller is remotely connected to the controllable forward based diode.

15. The method of claim 9, wherein the decision logic is remote from the controller.
